(19) United States
(12) Patent Application Publication
(10) Pub. No.: US 2014/0149204 A1
(43) Pub. Date: May 29, 2014

(54) SYSTEM AND METHOD FOR ADVERTISING VERIFICATION BASED ON USERS' DEMOGRAPHICS

(71) Applicant: MediaMind Technologies Ltd., Herzliya (IL)

(72) Inventors: Jonathan SCHLER, Petah Tikva (IL); Itay OVITS, Petah Tikva (IL)

(73) Assignee: MediaMind Technologies Ltd., Herzliya (IL)

(21) Appl. No.: 14/168,779

(22) Filed: Jan. 30, 2014

Related U.S. Application Data
(63) Continuation-in-part of application No. 13/221,623, filed on Aug. 30, 2011.

(51) Int. Cl. G06Q 30/02

(52) U.S. Cl. CPC G06Q 30/0242
USPC 705/14.41

(57) ABSTRACT

A system and method for performing demographic verification of an advertising campaign are provided. The method comprises generating a demographic profile for each user in a group of users; analyzing demographic profiles of viewers of the advertising campaign to determine at least a campaign reach of the advertising campaign, wherein the viewers of the advertising campaign are a subset of the users in the group of users; comparing the determined demographic campaign reach to at least one target audience attribute defined in a media plan of the advertising campaign; and verifying at least a demographic campaign reach based on the comparison.

### CROSS-REFERENCE TO RELATED APPLICATIONS

This application is a continuation-in-part application of U.S. patent application Ser. No. 13/221,623 filed on Aug. 30, 2011, the contents of which are herein incorporated by reference for all that they contain.

### TECHNICAL FIELD

The present invention relates generally to online advertising, and more particularly to demographic profiling of users for advertising verification.

### BACKGROUND

Websites, including commercial, corporate and personal websites, publish advertisements on their web pages. Such advertisements are typically published in the form of banners that may be comprised of static or rich media content. Banners that include rich media content are displayed as a combination of text, audio, still images, animation, video, and interactivity content for forms.

Online advertising campaigns are generally targeted at specific audiences. These audiences may be defined in terms of demographics or demographic parameters (e.g., gender, age, income, etc.) or in terms of interests (e.g., currently looking for a car, exercising Yoga, etc.). Targeting a specific audience has two distinct elements: first, the advertisement's creative aspects need to appeal to the specific audience; and second, the advertisement presentation or placement, regardless of the media used, needs to be suitable for the targeted audience. In the field of electronic advertising, each type of media has a set of proxies, or indicators, for making smart decisions regarding which placement is likely to be best for matching a campaign's targeted audience (e.g., in TV there are statistics as to the demographics and interests of each show).

In the field of online advertising, there are generally two approaches to targeting: user-centric and page-centric. The user-centric approach focuses on collecting data about each specific user, e.g., demographic data or parameters, and following the user's trace in order to target a specific audience. This approach requires tracking users across the internet, in order to match a specific viewed page to a specific user, or to a set of user-attributes. An alternative way of targeting is page-centric targeting. In this approach, a specific web page is analyzed, resulting in properties that can be attributed to it (e.g., its topic). These properties can be used as proxies to the type of audience viewing the page. For instance, a page that deals with automotive buying and selling are likely be considered relevant to users who are interested in buying or selling a car.

In addition to targeted advertisements profiling, profiling can also be utilized for advertising verification of either users or webpages. It should be noted that publishers, agencies, and marketers use advertising verification systems and services to validate the delivery of display advertisements and to ensure brand safety. Specifically, online advertising verification ensures that an advertisement's impression is a real impression and further, that the webpage's content is compliant with the targeting set for the campaign. For example, the verification can be utilized to determine if the advertisements are executed over content deemed inappropriate (e.g., not according to the media plan), if the advertisements are outside of the geographical targeting criteria designated in the media plan, that the counted impressions are not fraudulent, that the advertisements were served to the target audience, and that the advertisements were in compliance with other criteria as defined in the media plan.

It is generally accepted today that the only type of audience that can be targeted in this way is one defined by the audience's interests, and not by individual attributes, like demographics. Other advertising verification solutions are directed to classifying an entire web site when attempting to generate a web-site's audience profile. Accordingly, current solutions are designed to perform advertising verification based on the demographics of actual users who were exposed to or who viewed the advertised content.

It would therefore be advantageous to provide a solution that would overcome the deficiencies of the prior art with regard to online advertising verification.

### SUMMARY

Certain embodiments disclosed herein include a system and method for performing demographic verification of an advertising campaign. The method comprises generating a demographic profile for each user in a group of users; analyzing demographic profiles of viewers of the advertising campaign to determine at least a campaign reach of the advertising campaign, wherein the viewers of the advertising campaign are a subset of the users in the group of users; comparing the determined demographic campaign reach to at least one target audience attribute defined in a media plan of the advertising campaign; and verifying at least a demographic campaign reach based on the comparison.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a diagram of a network system utilized to describe the various disclosed embodiments.

FIG. 2 is a block diagram of a system for generating users' demographic profiles according to one embodiment.

FIG. 3 is a flowchart illustrating an online advertising verification method according to one embodiment.

FIG. 4 is a flowchart illustrating creation of a user's demographic profile according to one embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

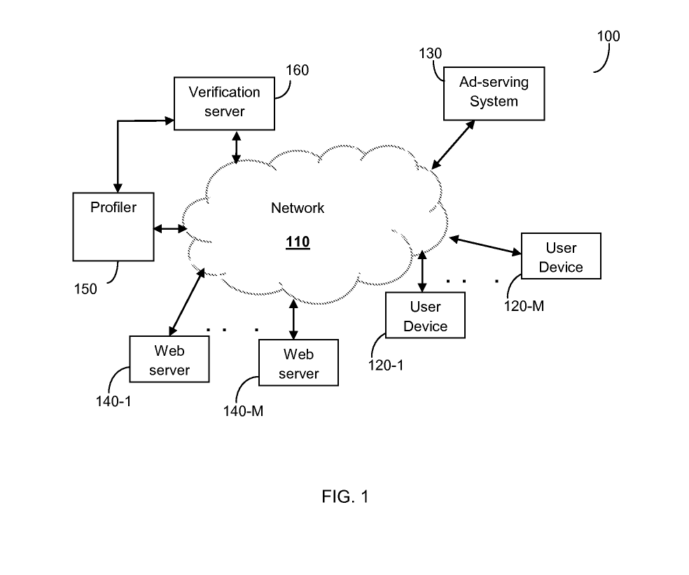

FIG. 1 shows an exemplary and non-limiting schematic diagram of a network system 100 utilized to describe the disclosed embodiments. The system 100 includes a network 110, which may be the Internet, the world-wide-web (WWW), a local area network (LAN), a wide area network (WAN), a metro area network (MAN), and the like.

As illustrated in FIG. 1, a plurality of user devices 120-1 through 120-N, at least one ad-serving system 130, a plurality of web servers 140-1 through 140-M, a profiler 150, and a verification server 160 are communicatively connected to the network 110. Each user device 120 may be, but is not limited to, a personal computer (PC), a personal digital assistant (PDA), a mobile phone, a smart phone, a tablet computer, a laptop, and the like, having capabilities for downloading and displaying webpages.

The web servers 140-1 through 140-M host websites accessible through the user devices 120-1 through 120-M. The webpages provided by the servers 140 may include advertisements served by the ad-serving system 130. In a typical deployment, a webpage downloaded from a web server 140 includes a piece of code that calls for the system 130 to place an advertisement in the web page.

For each served advertisement, the ad-serving system 130 is configured to collect data respective to the served advertisement. Such data will be referred to hereinafter as “ad-serving data,” and includes URLs of the web pages in which advertisements are placed, geo-information of users (of devices 120) who accessed the URLs and websites, domain names of the pages' websites, impression counts, time and data that each URL was accessed, a unique identifier of a user device 120 that viewed the advertisement, and so on.

The ad-serving data collected over a predefined period of time (e.g., one month) is provided to the profiler 150 for processing. It should be noted that the ad-serving data can be collected for many different campaigns over a large number of websites in which the campaigns run. Therefore, the ad-serving data includes an extensive list of URLs (e.g., millions of records) visited by a large number of users through user devices 120-1 through 120-M, over a certain period of time. The entire collection of ad-serving data represents targeted audiences of different campaigns. The ad-serving data can be arranged to provide all users who accessed a particular URL. The users are identified by their unique identifier such as, for example, a cookie. The ad-serving data can be sorted, for example, by geographical location of users, or by any entity in the collected information.

In an embodiment, URLs in the collected data are URLs visited by the users of the advertisement's campaign to be monitored and verified by a verification system 160. The users of the user devices 120 may be, in part, the target audience of a campaign to be verified.

The ad-serving data collected and arranged by the ad-serving system 130 is fed into the profiler 150. According to the disclosed embodiments, the profiler 150 is configured to perform demographic profiling of a set of users based on the URLs that the users visited. The profiling is performed at a user level, i.e., per user of a user device 120-1 through 120-M. It should be noted that the profiling may be performed without having any knowledge about the identity of the users (e.g., a user name). Furthermore, the users are not required to provide any identifying details (e.g., age, name, gender, etc.) about themselves to be profiled.

In an embodiment, the profiler 150 is configured to generate one or more user demographic parameters including, for example, age, gender, hobby(s), income, residence address or location, education, and/or an ethnic group. The user demographic attributes may be related to social or economic factors, e.g., education, residence, or income. Other examples of demographic parameters may be any information related to skills, occupation, health, trade, race, disabilities, mobility, home ownership, employment status, marital status, number of children, location, or cultural background.

The demographic profiling of users is provided based on one more heuristics applied to content attributes of visited webpages (referred to by the URLs). Content attributes may be any data, metadata, or other information related to the URL or to the respective page content. Exemplary content attributes may be, but are not limited to, a topic or a set of topics, the nature and purpose of the page (e.g., a blog, forum, news, etc.); amount of text or other information elements in the page; popularity; language; usage of colors; images or fonts; a writing style; number, location and size of advertisements within the page; pages' domain or section as indicated by the URL; “query parameters;” value of query parameters, e.g., search query, attributes of the site in which the page is hosted (e.g., number of pages, rate of content change, physical location of hosting); or attributes of other sites the user is directed to by links within the page. For example, a content attribute may be a topic discussed in a web page, a layout of a web page, or a font size or color.

A content attribute may be expressed, represented, or reflected by a set of discrete values, or by a continuous gradual scale. For example, a popularity of a web page may change throughout a day and may be expressed accordingly by a function that may produce different popularity values at different times of a day. In another example, a layout attribute may be expressed, represented, or reflected by a set of values related to more than one aspect, e.g., related to an orientation, an average size of images, and a level of separation between images and text.

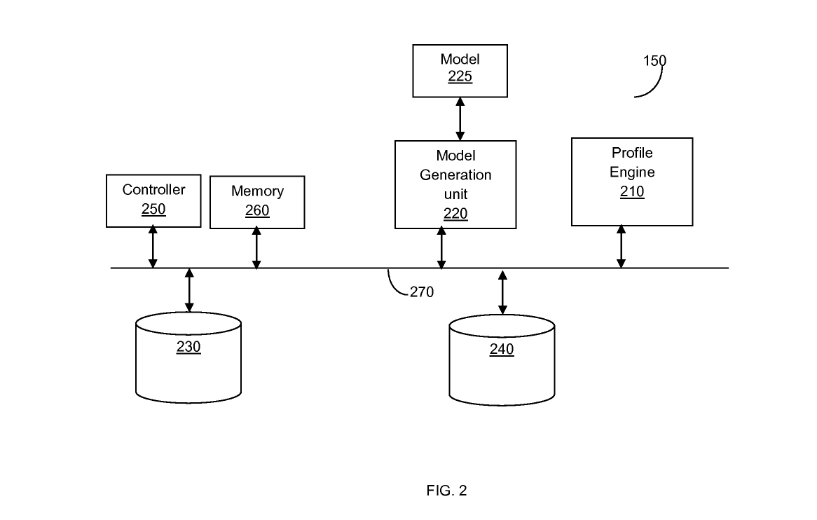

FIG. 2 shows a non-limiting exemplary block diagram of the profiler 150 according to an embodiment. The profiler 150 includes a profile engine 210, a model generation unit 220 that maintains a model 225, an ad-serving data storage unit 230 utilized to maintain the collected ad-serving data, and a users' demographic profiles storage unit 240 utilized to maintain the demographic profiles generated for the users.

To generate a user demographic profile, the engine 210 retrieves all URLs accessed by a particular user from the storage 230. Such URLs are fed to the model generation unit 220. In some embodiments, when provided with a URL, the model generation unit 220 is configured to obtain the related content object (e.g., webpage) referenced, or pointed to, by the URL and to provide the demographic information of the content object (e.g., web page) and of the user. Specifically, the model generation unit 220 is configured to analyze the content object (e.g., a web page) and determine one or more content attributes of the object. For example, a web page may be analyzed, thereby permitting attributes such as fonts' attributes, relevant topics, or layout to be determined. The model generation unit 220 is configured to associate attributes of a web page with demographic parameters based on any predefined and configurable scheme, heuristic, or logic. The model generation unit 220 updates the model based on an association of one or more content attributes with one or more demographic parameters or values.

Accordingly, the model 225 may be used to associate a content attribute with a demographic parameter. For example, when provided with a content attribute, the model 225 may provide one or more associated demographic parameters. In an embodiment, the model generation unit 220 first queries the model with content attributes of a web page prior to analyzing such attributes. Therefore, if the model 225 already contains the demographic parameters for a given set of content attributes, such attributes are not processed by the model 225.

It should be noted that the model generation unit 120 is configured to generate, update, or otherwise maintain the model 125 respective of content objects (e.g., web pages) based on information of anonymous users. For example, an age or gender of a real user and a web page requested by the user may suffice in order to update a model; the actual identity of the user may not be known or recorded.

That is, in one embodiment, the model generation unit 220 is configured to receive a web page (or other content object), analyze the web page to determine its content attributes, associate one or more content attributes with one or more demographic parameters, and update the model 225 based on the association. Various mechanisms, logic or methods may be used in order to associate content attributes to demographic parameters. In one embodiment, statistical methods or heuristics are used in order to determine an association of content attributes of web pages with demographic parameters. For example, the model generation unit 120 is configured to observe web pages having a specific content attribute (e.g., a specific font style) that are typically or mostly requested by young females, e.g., females between the ages of twelve and fifteen (12-15) years old.

Accordingly, the model 225 may be updated to reflect an association of an attribute that may be a “specific font style” with a demographic parameter or value that may be a “female between the ages of twelve and fifteen”. As another example, an attribute such as a specific writing style may be associated with an occupation (e.g., physicians) and a hobby (e.g., fishing). In yet another example, a specific skill, e.g., related to mathematics, may be associated with a number of content attributes, e.g., with a specific font size and with a specific font color.

Association of one or more demographic attributes with an attribute of a web page may be made according to a probability, factor, weight, or score. For example, an association of the age group 23-27 with a specific page layout may be also be associated with a probability of 0.87; and an association of a gender (e.g., female) with the same page layout may be associated with a probability of 0.93.

Any method, logic or scheme may be used to associate a probability to an association of demographic parameters with content attributes. A probability may reflect a matching level of a demographic parameter, or a value with a content attribute. For example, a probability value related to an association of a specific demographic parameter with a specific content attribute may be determined based on the percentage or number of users having the specific demographic parameter who also requested pages that have the same specific attribute. For example, if 90% of the users requesting pages with a specific layout are females, and 56% of the users requesting pages with the same specific layout are older than 50 years of age, then an association of a first demographic parameter (“female”) with the content attribute (the “specific layout”) may be assigned a probability of 0.9 and an association of a second demographic parameter (“older than 50 years of age”) with the same content attribute (the specific layout) may be assigned a probability or score of 0.56.

A set of content attributes and their values may be associated with a set of demographic-parameter distributions. The association rules for performing such that associations may be generated by any method, technique, or by an algorithm. For instance, a set of “machine learning” algorithms may be used to efficiently generate such association rules, with corresponding confidence values. For example, such a method may generate an arbitrary mathematical function that matches the values of certain content attributes, for example, font size and page colors, with a distribution of demographic attributes, for example, the probability of the user belonging to each of a set of age-groups. Furthermore, such a function may also present the chances of the rule being correct.

Accordingly, two or more different demographic parameters may be associated with a content attribute according to respective first and second probability values. Any number of content attributes may be associated with any number of demographic attributes. For example, a first content attribute of a web page, e.g., a topic, may be associated with one or more demographic attributes (possibly according to a respective one or more probabilities), and a second attribute of the same web page (e.g., a layout style) may be associated with a second set of one or more demographic attributes, possibly according to a second set of probabilities.

Association of demographic parameters with content attributes, e.g., in the model 225, may be dynamic. For example, by continuously, periodically, or otherwise monitoring requests for web pages and observing related user demographics, the information model 225 may be dynamically updated or maintained, possibly in real-time.

Various heuristics may be used in order to assign scores to associations. For example, a score assigned to an association of a demographic parameter with an attribute of a web page may be determined based on an indication that the association is indeed relevant or adequate. For example, a user input (e.g., in response to a questionnaire) may be used in order to verify an association of demographic parameters with web pages attributes. In other cases, a success of an advertising campaign or a rate of interaction with advertisements may be used as an indication of a correct or adequate association of user demographic information with content attributes.

For example, based on an association of user demographic parameters with a web page attribute, advertisements to be placed in the web page may be selected. A rate or amount of users' interactions with the advertisements may be used as a measure or other indication of the quality or correctness of an association of demographic information with content attributes. A model may be updated based on any input, result, or other data, e.g., rate of interactions with advertising content.

A score may be associated with, or assigned to, an association of a demographic parameter with an attribute of a content object. For example, a first demographic parameter may be associated with an attribute of a web page and the association may also be given a first score. A second demographic parameter may be associated with the same or other attribute of the web page and the second association may be given a second score. Accordingly, a web page may be associated with a number of demographic parameters (e.g., an age, a gender, and an occupation) and the associations may be given or assigned scores that may reflect a match level of the demographic parameter with the page. Accordingly, based on one or more attributes of a web page, embodiments of the invention may provide, possibly in real-time, an association of the web page with one or more demographic parameters and may further provide a probability or score (that may be viewed as a match level) for the association. Accordingly, the profile engine 210 is provided with information that may be useful in determining the demographic profiles for the users.

A calculation of a score may be based on any applicable parameters, data, or information. A score or probability assigned to an association of demographic parameters with content attributes may be dynamic. For example, a score of an association of a demographic parameter with an attribute of a web page may be based on information other than the specific attribute. As another example, a demographic parameter (e.g., an age) may be associated with a web page attribute (e.g., a font size) and the association may be given a first score. However, the same association may be given a second, different score if the web page includes specific content, if the web page is requested during a specific time of day, etc. For instance, a score of 10 for an association of an attribute of a web page with a demographic parameter which is “younger than 11 years of age” may be reduced to 6 between 03:00 and 05:00 AM assuming that users under the age of 11 are not likely to be surfing the internet during such times. Accordingly, scores (and/or probabilities) may be dynamically set.

Assigning scores, probabilities, or match levels to an association of a demographic parameter with a content attribute may be performed at more than one stage or with respect to more than one operation. For example, a mapping of a content attribute to a demographic parameter in a model may be given or assigned a score or probability that may reflect a confidence or match level related to the mapping of the demographic parameter to the content attribute in the model.

The model 225 may contain an association or mapping of content attributes with/to demographic parameters or values. Accordingly, the model 225 may be used to determine or select a demographic parameter or value based on a content attribute.

In response to the URLs provided by the profile engine 210, the model generation unit 220 returns the demographic parameters or information of users who may be interested in the content of the web pages referred to by the URLs. Accordingly, by providing a URL of a web page, demographic parameters or information about each user requesting the web page may be determined.

According to various disclosed embodiments, the profile engine 210 is configured to process all demographic parameters or information returned by the unit model generation unit 210 for URLs requested by a specific user to determine the user's demographic profile. Various statistical methods can be utilized to determine the user's profile. In an embodiment, the user may be determined by combining all the returned demographic parameters to generate a user profile. In another embodiment, the profile engine 210 considers only demographic parameters having a confidence or match level above a predefined threshold. In yet another embodiment, the profile engine 210 considers only demographic parameters associated with the most requested URLs over a predefined period of time (e.g., the top 10 popular websites of the user). The profile engine 210 can also use any combination of these embodiments to determine which demographic parameters to include in the user's demographic profile.

As an example, if the demographic parameters for a first set of URLs visited by the user indicate “female,” another set of demographic parameters for a second set of URLs visited by the user indicate “soccer,” and demographic parameters for a third set of URLs visited by the user indicate the age group of 18-22, the demographic profile for this user would be “female between 18 and 22 years old interested in soccer.”

In an embodiment, a profile confidence score is computed for the generated profile and is indicated by the probability that the generated profile reflects the real demographics of a respective user. The profile confidence score may be computed as a function of a number of processed URLs, and/or the confidence scores of the demographic parameters included in the profile.

The user demographic profile is saved in the storage unit 240 together with the unique identifier (e.g., cookie) of the user. It should be noted that the demographic profile can be generated for users that accessed a webpage with at least one ad served by the ad-serving system 130. The storage units 230 and 240 may include non-transitory medium and may be realized as, for example, a database and associated application, a hard disk drive, a universal serial bus (USB) device, or other suitable removable and/or fixed storage unit.

The profiler 150 may also include a controller 250 that may be but is not limited to, for example, a central processing unit (CPU), a chip, or any suitable computing or computational device. The profiler 150 may further include a memory 260. The memory 260 may include a plurality of instructions or code executable by the controller 250. The executable code may be an application, a program, a process, a task, or a script programmed to perform the processes described above. The executable code may be executed on or by the controller 260, the profile engine 210, and the model generation unit 210. The profiler 150 may also include a network interface to provide communication to the network 100.

The memory 260 may be or may include, but is not limited to, a non-transitory storage medium, a Random Access Memory (RAM), a read only memory (ROM), a Dynamic RAM (DRAM), a Flash memory, a volatile memory, a non-volatile memory, a cache memory, a buffer, a short or long term memory unit, or any other suitable memory units or storage units. The memory 260 may be or may include a plurality of different memory units. The various elements of the profiler 150 are communicatively connected via a bus 270.

In certain disclosed embodiments, the users' demographic profiles are utilized in part by the verification server 160 to perform advertising verification for campaigns served, for example, by the ad-serving system 130. To this end, the verification server 160 receives ad-serving data related to a specific campaign (hereinafter “campaign data”) to be verified. Such data may include URLs of websites that published the advertisements, a campaign ID, advertisements' IDs, time and data that each advertisement URL was visited, geographical location of users that visited the URLs, and so on. The campaign data may also include a unique identifier (e.g., a cookie) of a user who visited a URL.

The primary task of the verification server 160 is to determine if the campaign's reach satisfies the targeted audience as defined by the campaign's media plan. For each URL in the campaign data, the verification server 160 is configured to query the profiler 150 to retrieve the demographic profile of each user that visited the URL. The identification of the users that accessed a URL is based on the user unique identifier that was either included in the campaign data or in the ad-serving data stored in the storage unit 230 (see FIG. 2).

The verification server 160 is configured to process the demographic profiles received from the profiler 150 to determine a demographic reach of the campaign. In one embodiment, the demographic reach is determined by correlating the demographic parameters included in the profiles. In certain embodiments, statistical methods can be utilized to further process the correlation results. In a further embodiment, such processing may include establishing threshold values for inclusion in the demographic reach. For example, if a threshold value of 10% is used and if 2% of the received profiles have demographic parameters of the age group of 10-16, 70% of the received profiles have demographic parameters of the age group of 21-30, and the remaining profiles indicate the age group of 30-35, then the age group of 10-16 will be filtered out from the determined demographic reach.

It should be noted that the campaign's demographic reach may include any combination, aggregation, and/or association of demographic parameters contained in the users' demographic profiles. Examples for such parameters include age, gender, hobby(s), income, residence address or location, education, ethnic group, occupation, health, trade, race, disabilities, mobility, home ownership, employment status, marital status, number of children, cultural background, and so on.

In an embodiment, the campaign's demographic reach generated by the server 160 provides, for each demographic parameter, a measure (percentage) of the campaign's viewers that can be characterized by the parameter. For example, out of the campaign's viewers, 80% are married couples; 60% are females; and 70% are 45 years and older.

Upon the determination of the campaign demographic reach, the verification server 160 is configured to compare the reach to the campaign's media plan, to determine if the campaign's goals have been achieved. As a non-limiting example, if the media plan determines a targeted age group of 13-17, and the campaign's demographic reach delineates that reach of this age group (13-17) is only 7%, then the campaign's goal has not been achieved. In an embodiment, the comparison of the determined campaign's reach to targets as defined in the campaign's media plan is performed using various statistical methods and/or a preconfigured threshold.

In an embodiment, the verification process is performed off-line, i.e., it is not part of the ad-serving process. The verification process is typically performed when sufficient campaign data has been gathered. It should be appreciated that, because the verification process is based on demographic profiles of real users gathered across many different campaigns, accurate demographic verification is ensured for a specific campaign. The demographic verification includes at least verification of the campaign audience's typecast and interest.

In certain embodiments the verification process is configured to verify campaign targets or attributes other than the demographic verification. This may include for example, inappropriate content verification (e.g., the campaign being advertised in web pages that contain inappropriate and/or questionable content such as violence, adult content, etc.) and content language verifications.

In an embodiment, the inappropriate content language verification is performed by querying the profiler 150 for the content attributes of a web-page referred to by each URL included in the campaign data. As noted above, the profiler 150 using the model generation unit 220 and the model 225 is configured to provide such attributes. The verification server 160 is configured to process and analyze the retrieved content attributes to determine if they match the language(s) and/or are associated with web-pages that publish inappropriate content.

In an embodiment, the verification server 160 is further configured to perform geographical verification, i.e., to determine whether the campaign is being advertised in geographic locations as defined in the campaign's media plan. Such verification is performed by analyzing geographical information included in the gathered campaign data.

In one embodiment, the verification analysis results of different types of verifications may be reported or displayed through a GUI to a user (e.g., a campaign manager and advertising agency, etc.) of the verification server 160.

The verification server 160 can be realized as a computing or computational device including a controller, a CPU (not shown), and a memory (not shown). The memory may include a plurality of instructions or code executable by the CPU. The executable code may be an application, a program, a process, a task, or a script programmed to perform the verification processes as described above. The verification server 160 also includes a network interface to provide communication to the network 110 and a storage unit (not shown) to maintain campaign data and verification analysis results. In an embodiment, the profiler 150 or its functionality is integrated in the verification server 160.

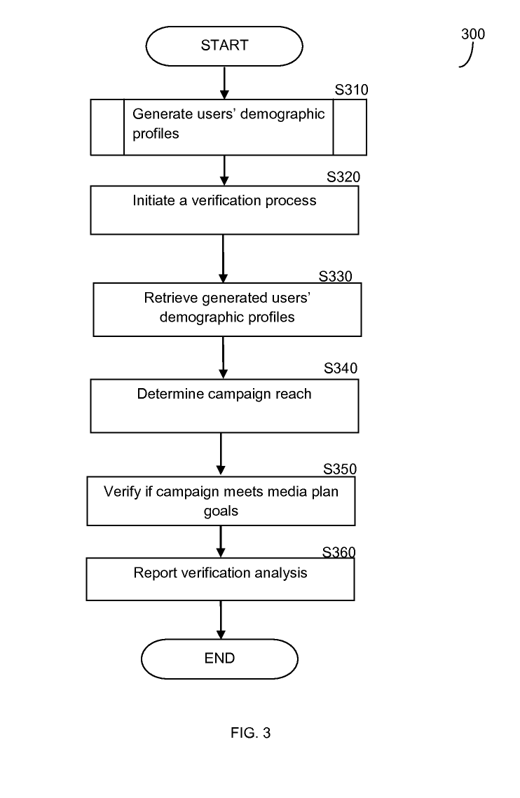

FIG. 3 shows an exemplary and non-limiting flowchart 300 describing a method for performing demographic verification of an advertising campaign according to one embodiment. The demographic verification is performed to check if the campaign indeed has been targeted to one of the specific audiences defined for the campaign.

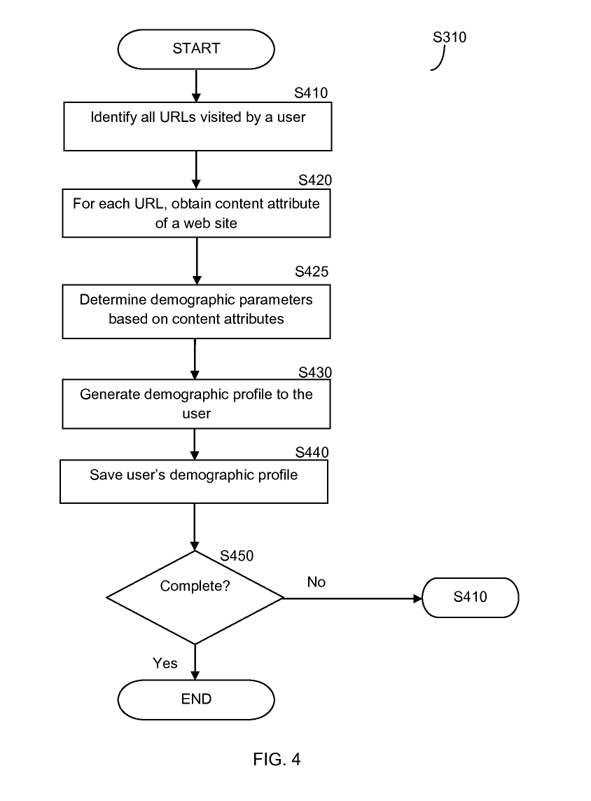

At S310, prior to or in parallel with the verification process, demographic profiles of users are created. The users are people who have viewed advertised content in different web sites. Each user is tracked and identified using a unique identifier (e.g., a cookie). Each user's demographic profile includes one or more demographic parameters. Examples for such parameters are provided above. The process for generating the demographic profiles is discussed in greater detail with respect to FIGS. 2 and 4. In an embodiment, S310 would result in storing profiles in a database (or other storage means) that maintains the generated users' demographic profiles.

At S320, a verification process is initiated. This may occur when enough campaign data is collected; this may be after the campaign is concluded or upon a request of a user of the verification system that such data is ready for processing. As noted above, such data may include URLs of web sites that published the advertisements, a campaign ID, advertisements' IDs, time and date that each advertisement URL was visited, geographical locations of users that visited the URLs, and so on. The campaign data may also include a unique identifier (e.g., a cookie) of a user that visited a URL.

At S330, for each URL in the campaign, one or more users' demographic profiles associated with one or more users who visited the respective webpage are retrieved. As noted above, such webpages include an advertisement served by an ad-serving system (e.g., system 130). It should be noted that the profile may be generated based on the websites previously visited by the user, which may or may not be part of the campaign being verified. S330 would result in verification of the demographic profiles of all users who viewed (or were exposed) to advertisements included in the campaign. It should be noted that, in an embodiment, if the number of retrieved users' demographic profiles is below a certain predefined threshold, the verification process may not be performed.

At S340, the retrieved demographic profiles are analyzed to determine the campaign reach. This includes correlating, aggregating, and/or associating the various demographic parameters in the retrieved parameters. The correlating, aggregating, and/or associating of demographic parameters may be performed using various statistical methods. In an embodiment, the campaign's demographic reach provides, for each demographic parameter, a measure (percentage) of the campaign's viewers that can be characterized by the respective parameter.

At S350, the campaign reach is compared to target audience attributes as defined in the media plan of the campaign. S350 is performed to at least determine whether the campaign was successfully targeted to its intended audience. The comparison may be performed respective of the demographic parameters contained in the determined reach as compared to those related to the target audience attributes. For example, if the target audience attributes include gender, age, and income, only the demographic parameters respective to each of those attributes are used in the comparison. The comparisons may be performed using various statistical methods respective to one or more predefined thresholds.

As an example, the determined reach for the gender, age, and income parameters may be that 60% are females, that 70% are 45 years or older, and that 60% earn a median income. The target audience attributes are middle-age females with a median income. A verification threshold may be set to 50% for each demographic parameter. In this case, the campaign reach achieves the defined targeted audience, since the verification threshold corresponding to each parameter has been met or exceeded. In a counter example, if the audience attributes are young females with no income, the verification thresholds for each attribute are again set to 50%, and the determined reach is the same as in the previous example (i.e., 60% female, 70% that are 45 years or older, and that 60% earning a media income), the campaign fails to achieve its goals as the advertisements are not placed in websites that cater to the demographics of the targeted audience.

At S360, the verification results and analysis (including the determined reached audience) are reported or displayed through, e.g., a GUI.

FIG. 4 shows an exemplary and non-limiting flowchart S310 describing the process for generating demographic profiles of users according to one embodiment. At S410, for each user, the process identifies all URLs in the collected ad-serving data that the user visited. At S415, for each URL visited by the user, the method determines at least one content attribute of a web page referred to by the URL and requested by a user. For example, a URL may be extracted from a request received from a user. The URL may be used to generate content attributes such as, for example, site, section, query, etc.; alternatively, the URL may be used to obtain the web page. The web page may be analyzed and one or more content attributes may be determined. In particular, it should be noted that generating content attributes may not require accessing the web page pointed to by the URL, thereby enabling real-time matching.

At S425, the method determines one or more demographic parameters based on at least one content attribute of a web page. The determination may be based on one or more heuristics or methods as discussed in detail above.

At S430, the method generates the user demographic profile by correlating, combining, aggregating, and/or associating all demographic parameters determined for the web sites visited by the user. At S440, the user's demographic profile is saved in a storage unit. At S450, it is checked if the profiles are generated for all users identified in the ad-serving data and, if so, execution ends; otherwise, execution returns to S410 where a demographic profile for another user is generated.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for performing demographic verification of an advertising campaign, comprising:
generating a demographic profile for each user in a group of users;
analyzing demographic profiles of viewers of the advertising campaign to determine at least a campaign reach of the advertising campaign, wherein the viewers of the advertising campaign are a subset of the users in the group of users;
comparing the determined demographic campaign reach to at least one target audience attribute defined in a media plan of the advertising campaign; and
verifying at least a demographic campaign reach based on the comparison.

2. The method of claim 1, further comprising:
storing the demographic profiles in a database; and
reporting at least results of the comparison.

3. The method of claim 1, wherein the demographic profile of a user is generated based on campaign data collected across a plurality of advertising campaigns that the user viewed, wherein the campaign data includes at least URLs previously visited by the user.

4. The method of claim 1, further comprising:
analyzing the demographic profiles of the users when a number of users in the group of users is above a predefined threshold.

5. The method of claim 3, wherein the demographic profile includes at least one demographic parameter, wherein the at least one demographic parameter is any one of: age, gender, hobby, income, residence address, country, state, city, education, skills, occupation, health, trade, race, disability, home ownership or lack thereof, employment status, marital status, number of children, and cultural background.

6. The method of claim 5, wherein the demographic campaign reach is computed as a percentage of users who viewed the advertising campaign respective to each of the at least one demographic parameter.

7. The method of claim 5, wherein the demographic campaign's reach is computed by correlating at least one demographic parameter exceeding a predefined threshold.

8. The method of claim 3, further comprising:
collecting at least campaign data, wherein the campaign data includes at least one of: uniform resource locators (URLs), a campaign identification (ID), advertisement identifications, time of access of the URLs, date of access of the URLs, geographical locations of viewers, and cookies.

9. The method of claim 8, wherein analyzing the at least one demographic profile to determine the campaign reach begins upon occurrence of any one of: collection of a predetermined amount of campaign data, conclusion of the campaign, and receipt of a request to obtain demographic verification.

10. The method of claim 3, wherein generating the demographic profile for the user further comprising:
identifying all URLs that the user visited during the plurality of advertising campaigns;
for each URL visited by the user, determining at least one content attribute of a webpage referred to by the URL;
determining at least one demographic parameter based on at least one content attribute of the web page; and
producing the demographic profile of the user by processing demographic parameters determined by all the web pages visited by the user.

11. The method of claim 10, wherein the determination of the at least one demographic parameter is provided based, in part, on a plurality of heuristics applied to content attributes of visited webpages.

12. The method of claim 1, wherein the advertising campaign verification further comprises a geographical verification and content verification.

13. A non-transitory computer readable medium having stored thereon instructions for causing one or more processing units to execute the method according to claim 1.

14. A system for performing verification of an advertising campaign, comprising:
a network interface communicatively connected to a network;
a processor; and
a memory coupled to the processor, containing a plurality of instructions that when executed by the processor configure the system to:
generate a demographic profile for each user in a group of users;
analyze demographic profiles of viewers of the advertising campaign to determine at least the campaign reach of the advertising campaign, wherein the viewers of the advertising campaign are a subset of the users in the group of users;
compare the determined demographic campaign reach to at least one target audience attribute defined in a media plan of the advertising campaign; and
verify at least a demographic campaign reach based on the comparison.

15. The system of claim 14, further comprising:
a database for storing the demographic profiles.

16. The system of claim 14, wherein the demographic profile of a user is generated based on campaign data collected across a plurality of advertising campaigns that the user viewed, wherein the campaign data includes at least URLs previously visited by the user.

17. The system of claim 14, wherein the system is further configured to:
analyze the demographic profiles of the users when a number of users in the group of users is above a predefined threshold.

18. The system of claim 16, wherein the demographic profile includes at least one demographic parameter, wherein the at least one demographic parameter is any one of: age, gender, hobby, income, residence address, country, state, city, education, skills, occupation, health, trade, race, disability, home ownership or lack thereof, employment status, marital status, number of children, and cultural background.

19. The system of claim 18, wherein the demographic campaign reach is computed as a percentage of users who viewed the advertising campaign respective to each of the at least one demographic parameter.

20. The system of claim 18, wherein the demographic campaign reach is computed by correlating at least one demographic parameter exceeding a predefined threshold.

21. The system of claim 16, wherein the system is further configured to:
collect at least campaign data, wherein the campaign data includes at least one of: uniform resource locators (URLs), a campaign identification (ID), advertisement identifications, time of access of the URLs, date of access of the URLs, geographical locations of viewers, and cookies.

22. The system of claim 21, wherein analyzing the demographic profiles to determine the campaign reach begins upon occurrence of any one of: collection of a predetermined amount of campaign data, conclusion of the campaign, and receipt of a request to obtain demographic verification.

23. The system of claim 16, wherein the system is further configured to:
identify all URLs that the user visited during the plurality of advertising campaigns;
for each URL visited by the user, determine at least one content attribute of a webpage referred to by the URL;
determine at least one demographic parameter based on at least one content attribute of the web page; and
produce the demographic profile of the user by processing demographic parameters determined by all the web pages visited by the user.

24. The system of claim 22, wherein the determination of the at least one demographic parameter is provided based, in part, on a plurality of heuristics applied to content attributes of visited webpages.

25. The system of claim 14, wherein the advertising campaign verification further comprises a geographical verification and content verification.
